(19) United States
(12) Patent Application Publication
(10) Pub. No.: US 2011/0043922 A1
(43) Pub. Date: Feb. 24, 2011

(54) Vehicle Pane and Motor Vehicle Having a Vehicle Pane

(75) Inventors: Hans Multhaupt, Stuttgart (DE); Andreas Zygan, Malsch (DE); Juergen Schrader, Weil im Schoenbuch (DE); Uwe Siehler, Gaeufelden (DE); Alfred Ott, Gaeufelden (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/866,564

(22) PCT Filed: Feb. 4, 2009
(86) PCT No.: PCT/EP2009/000734

§ 371 Date: Nov. 12, 2010

(30) Foreign Application Priority Data
Feb. 7, 2008 (DE) 10 2008 008 018.7

(51) Int. Cl. B60J 3/04; B32B 17/00; B32B 3/10

(52) U.S. Cl. 359/614; 428/426; 428/210; 428/195.1

(57) ABSTRACT

A vehicle pane, particularly for a motor vehicle, has an outer layer and an inner layer between which, at least in sections, there is arranged a function layer which influences a light transmission characteristic of the vehicle pane. An additional function layer is provided, by which the light transmission characteristic of the vehicle pane can also be influenced. The invention further relates to a motor vehicle having at least one vehicle pane.

This application is a national stage of PCT International Application No. PCT/EP2009/000734, filed Feb. 4, 2009, which claims priority under 35 U.S.C. §119 to German Patent Application No. 10 2008 008 018.7, filed Feb. 7, 2008, the entire disclosure of which is herein expressly incorporated by reference.

### BACKGROUND AND SUMMARY OF THE INVENTION

The invention relates to a vehicle pane, particularly for a motor vehicle, as well as to a motor vehicle having at least one vehicle pane of this type.

A known vehicle pane of this general type, which is illustrated in a schematic cross-sectional view in FIG. 1, is constructed as a laminated pane for a roof glazing of a motor vehicle, comprising an outer layer 10 and an inner layer 12. A function layer, which is arranged at least in sections, between the outer and inner layers, can adjust a light transmission characteristic of the vehicle pane. In other words, the function layer 14 influences the light transmission (and thus the degree of darkening of the vehicle pane) so that a portion of a spectrum of a light entering according to the arrows Ia is absorbed or reflected and the remaining portion is transmitted according to the arrows Ib into an interior of the motor vehicle. The function layer 14 may also be switchable, and is coupled with an electrical power source, (not shown) in order to make available a light transmission characteristic that is adjustable to a certain extent.

The illustrated vehicle pane generates, for example, from sunlight that is incident according to the arrows Ia, a darkened light or, in the case of a switchably constructed function layer 14, a light that can be darkened and has a dark-blue color tone. Likewise, vehicle panes having function layers 14 are known which can be switched between a “clear” transparent and a “dim” condition in which they generate a diffuse white light without any significant darkening. In this case, the function layer 14 is usually constructed as a foil or is applied to the outer layer 10 or the inner layer 12 by means of a coating process.

A disadvantage of the known vehicle panes, including those having switchably constructed function layers 14, is that only the opacity or the transmission factor can be influenced. That is, the color (and therefore the transmitted portion of the spectrum of the incident light) is predefined.

It is therefore an object of the present invention to provide a vehicle pane of the initially mentioned type as well as a motor vehicle having such a vehicle pane, in the case of which a more variable light transmission characteristic is made possible.

This and other objects and advantages are achieved by the vehicle pane according to the invention, and by a motor vehicle having such a vehicle pane, which permits a more variable light transmission characteristic by providing at least one further function layer that can influence the light transmission characteristic of the vehicle pane. In other words, the vehicle pane comprises at least two function layers, whereby, in contrast to the prior art, an improved influence on the degree of darkening or of the light transmission, on the one hand, as well as of the coloring of the transmitted light, on the other hand, is made possible. This permits a significantly more flexible further development of the vehicle pane and an improved adaptability to different uses. By means of the interaction of the function layers, certain wavelength ranges can be absorbed in a targeted manner from the spectrum of the incident light and can be reflected, whereby the light transmission characteristic can be represented with an arbitrary coloring. The improved influence on the coloring also permits a correspondingly improved individualization of the vehicle pane as well as of a motor vehicle equipped with the vehicle pane. This permits an improved taking-into-account of customers' wishes and thereby ensures increased customer satisfaction.

In an advantageous embodiment of the invention, at least one function layer has a variable light transmission characteristic. As a result, an independent darkening of the vehicle pane can, for example, be achieved in the case of an intensive incident light radiation, whereby heating of the interior is reduced, and possible air-conditioning systems are relieved.

Furthermore, it was found to be advantageous for the at least one function layer to have a switchable construction and an adjustable light transmission characteristic. This permits a further increased variability of the light transmission characteristic of the vehicle pane, whereby, in an ideal case, a freely adjustable coloration can be displayed.

It is also advantageous to construct the function layer in a permanently colored manner. Switchable glazings often have an undesirable color characteristic which can be changed or at least reduced by an additional colored function layer. In this case, the function layer may also be constructed as a dyed foil. The dyed function layers can also respond to individual customer's wishes.

In that the outer layer and/or the inner layer itself is or are constructed as a function layer, two or more function layers arranged between the outer layer and the inner layer can be eliminated, and the vehicle pane can be constructed to be especially compact and space-saving in its cross-section. For this purpose, the outer and/or the inner layer are dyed to a color adapted to the light transmission of the additional function layer. Nevertheless, as required, two or more function layers can naturally be arranged between the outer layer and the inner layer in order to achieve a desired light transmission characteristic.

In this case, it was also found to be advantageous for at least two function layers to be arranged between the outer layer and the inner layer and to form a multifunction arrangement. In this manner, the function layers are reliably protected against mechanical damage, oxidation and the like. In addition, this compact arrangement of the function layers reduces optical dispersion and absorption losses, thereby permitting an especially exact selection of the wavelength ranges of the incident light to be transmitted.

In a further advantageous embodiment of the invention, it is provided that a preferably scratchproof and/or adhesive intermediate layer is arranged between the outer layer and one of the function layers and/or between the inner layer and one of the function layers and/or between at least two function layers. As a function of the further development of the intermediate layer, reliable protection of the function layer against any type of damage is also ensured. An adhesive intermediate layer permits a gluing-together—for example, by laminating—of the corresponding function layer, whereby a reliable cohesion of the laminar structure is achieved and the vehicle pane is provided with high stability.

Further advantages are achieved in that the outer layer and/or the inner layer, at least in regions, consist(s) of a glass, particularly a mineral glass, and/or of a synthetic material. Depending on the type and thickness of the used layer, the vehicle pane can thereby be optimally adapted to its respective purpose and can be used, for example, as a window pane, a safety pane, a soundproofing pane, a fire-resisting pane or a passage-inhibiting pane.

In a further advantageous embodiment of the invention, the pane may comprise a windshield, a side window, a rear window pane, a roof glazing and/or as a roof part of a top, particularly a folding top, for a motor vehicle. This permits a particularly flexible use for the vehicle pane, in which the respectively desired light transmission characteristic can be particularly easily adapted to the respective use. It can naturally also be provided that the vehicle pane includes further functions such as heating, metal-coating and the like.

In a further aspect, the invention relates to a motor vehicle having at least one vehicle pane according to one or more of the preceding embodiments. As a result of the more variable light transmission characteristic and the additional above-indicated advantages of the vehicle pane, it therefore becomes possible, in contrast to the prior art, to design the motor vehicle in a more individualized manner and to be able to better meet the customers' wishes with respect to coloration. Furthermore, functionalities, such as glare shielding, eye protection and protection against heat, can be integrated without any problems and without having to make concessions concerning the light transmission characteristic.

In this case, it was found to be advantageous for the light transmission characteristic of the vehicle pane to be adapted and/or adaptable to an interior color of the motor vehicle by means of the function layers. As a function of the further development of the vehicle pane, on the one hand, a particularly high degree of individualization and, on the other hand, a high functionality can be achieved.

Additional advantages are obtained in that, by means of the function layers, a remission characteristic of the vehicle pane is adapted and/or can be adapted to an exterior color of the motor vehicle. In other words, the function layers are constructed such that, in addition to the transmission and absorption characteristic, the reflection characteristic of the vehicle pane can also be influenced. As a result, the outside appearance of the motor vehicle equipped with the vehicle pane can be designed to be particularly variable and individualized.

It is also advantageous to provide, in a motor vehicle having a vehicle pane according to the inventive construction, a control device which can apply a permanent minimum voltage to the at least one function layer, because many switchable glazings have a considerable discoloration in the currentless condition, whereas, when acted upon by a very low voltage, they have less discoloration and therefore an appearance of a more neutral color. By means of the control device, this low minimum voltage can be permanently applied to the switchable glazing.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic lateral sectional view of a vehicle pane according to the prior art; and

FIG. 2 is a schematic lateral sectional view of a vehicle pane of the invention according to an embodiment.

### DETAILED DESCRIPTION OF THE DRAWINGS

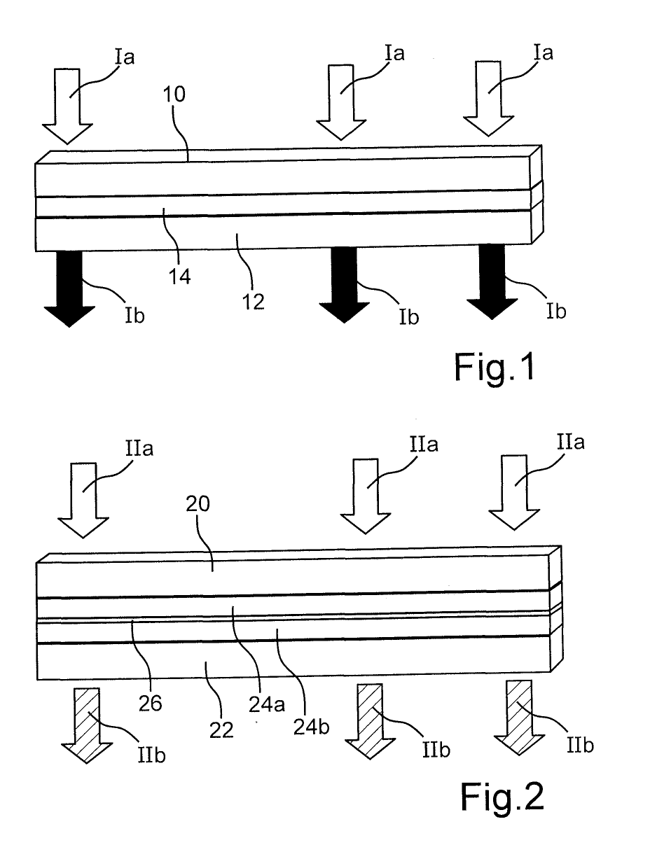

While FIG. 1 is a schematic lateral sectional view of a vehicle pane according to the prior art, FIG. 2 is a schematic lateral sectional view of a vehicle pane of an embodiment of the invention. The vehicle pane, which in the present case is constructed as a roof part or a partial region of a roof part of a folding top for a motor vehicle, also comprises an outer layer 20 and an inner layer 22 between which two function layers 24a, 24b are arranged and form a multifunction layer arrangement. As a result of the interaction of the function layers 24a, 24b, the vehicle pane according to the invention, in contrast to the vehicle pane illustrated in FIG. 1, permits a significantly improved influencing of the light transmission as well as of the coloration of the light transmitted according to arrows IIb. In this case, it may be additionally provided that one or both function layers 24a, 24b has or have a switchable construction and each has an individually adjustable light transmission characteristic. From the spectrum of the light incident according to the arrows IIa, flexibly adjustable wavelength ranges can be absorbed, reflected and transmitted, whereby a particularly variable light transmission characteristic can be displayed with an arbitrary coloration.

The illustrated vehicle pane offers a darkening functionality, which is particularly advantageous in the case of motor vehicles which, because of their size or shape, do not have sufficient space for a blind, a screen or the like. In this case, it may be provided that the vehicle pane is automatically darkened, as desired, as a protection against looking through the pane, or when the vehicle is parked.

In contrast to the prior art, the color tone of the light transmitted in the darkened condition according to arrows IIb can be freely adjusted so that also more neutral colorations without blue tones are conceivable. For example, also gray or cream-colored color tones can thereby be generated, whereby, for example, premium vehicles with brightly equipped interiors make a considerably improved impression with respect to comfort and quality.

As an alternative or in addition, it may be provided that the function layers 24 are constructed such that a remission characteristic of the vehicle pane can be adapted to the exterior color of the motor vehicle. Furthermore, naturally also functions, such as heating, shading or metal coating can be integrated in the vehicle pane.

In the illustrated example, an optional intermediate layer 26 is arranged between the two function layers 24a, 24b, which intermediate layer 26 provides an increased mechanical stability of the bonding of material and, in addition, also influences the light transmission characteristic. Instead of providing the illustrated function layers 24a, 24b, it may also be provided as an alternative or in addition that the outer layer 20 and/or the inner layer 22 themselves is or are constructed as a function layer 24.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-13. (canceled)

14. A vehicle pane, comprising:
an outer layer;
an inner layer;
a first functional layer, arranged at least in sections between said inner and outer layers, by which a light transmission characteristic of the vehicle pane can be influenced; and
a second function layer by which the light transmission characteristic of the vehicle pane can be further influenced.

15. The vehicle pane according to claim 14, wherein at least one of said first and second function layers has a variable light transmission characteristic.

16. The vehicle pane according to claim 15, wherein at least one function layer is switchable and has an adjustable light transmission characteristic.

17. The vehicle pane according to claim 16, wherein one of said function layers is permanently dyed.

18. The vehicle pane according to claim 14, wherein one of the outer layer and the inner layer is constructed as a function layer.

19. The vehicle pane according to claim 14, wherein said first and second function layers are arranged between the outer layer and the inner layer, and form a multifunction layer arrangement.

20. The vehicle pane according to claim 14, wherein at least one of a scratchproof layer and an adhesive intermediate layer is arranged between the outer layer and one of the first and second function layers, between the inner layer and one of the first and second function layers, or between the first and second function layers.

21. The vehicle pane according to claim 14, wherein at least one of the outer and inner layers, at least in regions, comprises at least one of glass, a mineral glass, and a synthetic material.

22. The vehicle pane according to claim 14, wherein this pane is constructed as at least one of a windshield, a side window, a rear window, a roof glazing, and a roof part of a top for a motor vehicle.

23. A motor vehicle having at least one vehicle pane comprising:
an outer layer;
an inner layer;
a first functional layer arranged at least in sections between said inner and outer layers by which a light transmission characteristic of the vehicle pane can be influenced; and
a second function layer by which the light transmission characteristic of the vehicle pane can be further influenced.

24. The motor vehicle according to claim 23, wherein the function layers are composed such that the light transmission characteristic of the vehicle pane is adaptable to an interior color of the motor vehicle.

25. The motor vehicle according to claim 23, wherein the function layers are composed such that a remission characteristic of the vehicle pane is adaptable to an exterior color of the motor vehicle.

26. The motor vehicle according to claim 23, further comprising a control device for applying a permanent minimum voltage to at least one of the first and second function layers.
